(19) United States
(12) Patent Application Publication
(10) Pub. No.: US 2008/0227625 A1
(43) Pub. Date: Sep. 18, 2008

(54) Catalyst For NOx And/Or SOx Control

(76) Inventor: David M. Stockwell, New Jersey, VA (US)

Correspondence Address: BASF CATALYSTS LLC, 100 CAMPUS DRIVE, FLORHAM PARK, NJ, 07932, US

(21) Appl. No.: 12/109,386

(22) Filed: Apr. 25, 2008

Related U.S. Application Data
(62) Division of application No. 10/920,827, filed on Aug. 18, 2004.

(51) Int. Cl. B01J 38/04

(52) U.S. Cl. 502/34

(57) ABSTRACT

A catalytic additive for reducing NOx, SOx, and/or precursors thereof in a regenerator flue gas comprises an alkaline earth metal, phosphorous, and at least one transition metal on an alumina-based support.

### FIELD OF THE INVENTION

This invention relates to regeneration of spent catalyst in a fluid catalytic cracking (FCC) process and the reduction of NOx and NOx precursor emissions from a regenerator that is operated in an incomplete mode of CO combustion. The invention is also directed to a catalyst for SOx reduction which has improved NOx reduction performance in full or partial burn.

### BACKGROUND OF THE INVENTION

Catalytic cracking of heavy petroleum fractions is one of the major refining operations employed in the conversion of crude petroleum oils to useful products such as the fuels utilized by internal combustion engines. In fluidized catalytic cracking processes, high molecular weight hydrocarbon liquids and vapors are contacted with hot, finely-divided, solid catalyst particles, either in a fluidized bed reactor or in an elongated transfer line reactor, and maintained at an elevated temperature in a fluidized or dispersed state for a period of time sufficient to effect the desired degree of cracking to lower molecular weight hydrocarbons of the kind typically present in motor gasoline and distillate fuels.

In the catalytic cracking of hydrocarbons, some non-volatile carbonaceous material or coke is deposited on the catalyst particles. Coke comprises highly condensed aromatic hydrocarbons and generally contains from about 4 to about 10 weight percent hydrogen. When the hydrocarbon feedstock contains organic sulfur and nitrogen compounds, the coke also contains sulfur and nitrogen species. As coke accumulates on the cracking catalyst, the activity of the catalyst for cracking and the selectivity of the catalyst for producing gasoline-blending stocks diminishes.

Catalyst which has become substantially deactivated through the deposit of coke is continuously withdrawn from the reaction zone. This deactivated catalyst is conveyed to a stripping zone where volatile deposits are removed with an inert gas or steam at elevated temperatures. The catalyst particles are then reactivated to essentially their original capabilities by substantial removal of the coke deposits in a suitable regeneration process. Regenerated catalyst is then continuously returned to the reaction zone to repeat the cycle.

Catalyst regeneration is accomplished by burning the coke deposits from the catalyst surfaces with an oxygen containing gas such as air in a regenerator separate from the fluidized reactor used in catalytic cracking. In the catalyst regenerator, the coke burns off, restoring catalyst activity and heating the catalyst to, e.g., 500-900° C., usually 600-750° C. Flue gas formed by burning coke in the regenerator may be treated to remove particulates and convert carbon monoxide, after which the flue gas is normally discharged into the atmosphere.

The removal of carbon monoxide from the waste gas produced during the regeneration of deactivated cracking catalyst can be accomplished by conversion of the carbon monoxide to carbon dioxide in the regenerator or carbon monoxide boiler after separation of the regeneration zone effluent gas from the catalyst.

Initially, there was little incentive to attempt to remove substantially all coke carbon from the catalyst, since even a fairly high carbon content had little adverse effect on the activity and selectivity of amorphous silica-alumina catalysts. Most of the FCC cracking catalysts now used, however, contain zeolites, or molecular sieves. Zeolite-containing catalysts have usually been found to have relatively higher activity and selectivity when their coke carbon content after regeneration is relatively low. An incentive then arose for attempting to reduce the coke content of regenerated FCC catalyst to a very low level.

When the regenerators operate in a complete CO combustion mode, the mole ratio of CO₂/CO is at least 10 in the regenerator flue gas. During regeneration operated at complete combustion mode, several methods have been suggested for burning substantially all carbon monoxide to carbon dioxide to avoid air pollution, recover heat, and prevent afterburning. Among the procedures suggested for use in obtaining complete carbon monoxide combustion in an FCC regeneration have been: (1) increasing the amount of oxygen introduced into the regenerator relative to standard regeneration; and either (2) increasing the average operating temperature in the regenerator or (3) including various carbon monoxide oxidation promoters in the cracking catalyst to promote carbon monoxide burning. Various solutions have also been suggested for the problem of afterburning of carbon monoxide, such as addition of extraneous combustibles or use of water or heat-accepting solids to absorb the heat of combustion of carbon monoxide.

Specific examples of treatments applied to regeneration operated in the complete combustion mode include the addition of a CO combustion promoter metal to the catalyst or to the regenerator. For example, U.S. Pat. No. 2,647,860 proposed adding 0.1 to 1 weight percent chromic oxide to a cracking catalyst to promote combustion of CO. U.S. Pat. No. 3,808,121 taught using relatively large-sized particles containing CO combustion-promoting metal into a regenerator. The small-sized catalyst is cycled between the cracking reactor and the catalyst regenerator while the combustion-promoting particles remain in the regenerator. Also, U.S. Pat. Nos. 4,072,600 and 4,093,535 teach the use of Pt, Pd, Ir, Rh, Os, Ru, and Re in cracking catalysts in concentrations of 0.01 to 50 ppm, based on total catalyst inventory to promote CO combustion in a complete burn unit. Most FCC units now use a Pt CO combustion promoter. While the use of combustion promoters such as platinum reduce CO emissions, such reduction in CO emissions is usually accompanied by an increase in nitrogen oxides (NOx) in the regenerator flue gas.

It is difficult in a catalyst regenerator to completely burn coke and CO without increasing the NOx content of the regenerator flue gas. Many jurisdictions restrict the amount of NOx that can be in a flue gas stream discharged to the atmosphere. In response to environmental concerns, much effort has been spent on finding ways to reduce NOx emissions.

For example, NOx is controlled in the presence of a platinum-promoted complete combustion regenerator in U.S. Pat. No. 4,290,878, issued to Blanton. Recognition is made of the fact that the CO promoters result in a flue gas having an increased content of nitrogen oxides. These nitrogen oxides are reduced or suppressed by using, in addition to the CO promoter, a small amount of an iridium or rhodium compound sufficient to convert NOx to nitrogen and water. U.S. Pat. No. 4,300,997 to Meguerian et al. discloses the use of a promoter comprising palladium and ruthenium to promote the combustion of CO in a complete CO combustion regenerator without simultaneously causing the formation of excess amounts of NOx. The ratio of palladium to ruthenium is from 0.1 to about 10.

As opposed to complete CO combustion, older FCC catalyst regenerators are operated in an incomplete mode of combustion, and these are commonly called “partial burn” units. Incomplete CO combustion leaves a relatively large amount of coke on the regenerated catalyst which is passed from an FCC regeneration zone to an FCC reaction zone. The relative content of CO in the regenerator flue gas is relatively high, i.e., about 1 to 10 volume percent. A key feature of partial combustion mode FCC is that the heat effect of coke burning per weight of coke is reduced because the exothermic CO combustion reaction is suppressed. This enables higher throughput of oil and lower regenerator temperatures, and preservation of these benefits is essential to the economics of the FCC process. Under incomplete combustion operation NOx may not be observed in the regenerator flue gas, but sizable amounts of ammonia and HCN are normally present in the flue gas. According to U.S. Pat. No. 4,744,962, the regenerator flue gas formed under incomplete combustion typically comprises about 0.1-0.4% O₂, 15% CO₂, 4% CO, 12% H₂O, 200 ppm SO₂, 500 ppm NH₃, and 100 ppm HCN. If the ammonia and HCN are allowed to enter a CO boiler, much of the ammonia and HCN will be converted to NOx.

During regeneration, at least a portion of the sulfur that is deposited on the catalyst during cracking leaves the regenerator in the form of sulfur oxides (SO₂ and SO₃), known as SOx. Considerable recent research effort has been directed to the reduction of sulfur oxide emissions in stack gases from the regenerators of FCC units. One technique involved circulating one or more metal oxides with the cracking catalyst inventory in the regeneration zone and capable of associating with oxides of sulfur. When the particles containing associated oxides of sulfur are circulated to the reducing atmosphere of the cracking zone, the associated sulfur compounds are released as gaseous sulfur-bearing material such as hydrogen sulfide which is discharged with the products from the cracking zone and are in a form readily handled in FCC units. The metal oxide reactant is regenerated to an active form, and is capable of further associating with sulfur oxides when cycled to the regenerator.

Incorporation of Group IIA metal oxides on particles of cracking catalyst in such a process has been proposed (U.S. Pat. No. 3,835,031 to Bertolacini). In a related process described in U.S. Pat. No. 4,071,430 to Blanton et al, discrete fluidizable alumina-containing particles are circulated through the cracking and regenerator zones along with physically separate particles of the active zeolitic cracking catalyst. The alumina particles pick up oxides of sulfur in the regenerator, forming at least one solid compound, including both sulfur and aluminum atoms. The sulfur atoms are released as volatiles, including hydrogen sulfide, in the cracking unit. U.S. Pat. No. 4,071,436 further discloses that 0.1 to 10 weight percent MgO and/or 0.1 to 5 weight percent Cr₂O₃ are preferably present in the alumina-containing particles. Chromium is used to promote coke burnoff. Similarly, a metallic component, either incorporated into catalyst particles or present on any one of a variety of “inert” supports, is exposed alternately to the oxidizing atmosphere of the regeneration zone of an FCCU and the reducing atmosphere of the cracking zone to reduce sulfur oxide emissions from regenerator gases in accordance with the teachings of Belgian Patents 849,635, 839,636 and 849,637 (1977). In Belgian 849,637, a metallic oxidation promoter such as platinum is also present when carbon monoxide emissions are to be reduced. These patents disclose nineteen different metallic components, including materials as diverse as alkaline earths, sodium, heavy metals and rare earth, as being suitable reactants for reducing emissions of oxides of sulfur. The metallic reactants that are especially preferred are sodium, magnesium, manganese and copper. When used as the carrier for the metallic reactant, the supports that are used preferably have a surface area at least 50 square meters per gram. Examples of allegedly “inert” supports are silica, alumina and silica-alumina. The Belgian patents further disclose that when certain metallic reactants (exemplified by oxides of iron, manganese or cerium) are employed to capture oxides of sulfur, such metallic components can be in the form of a finely divided fluidizable powder.

Catalysts for SOx reduction have generally developed without regard for their impact on NOx, although some effectiveness for reducing NOx has been asserted for these compositions. The utility of prior art SOx additives for SOx transfer is apparently limited in practice by the rate of reduction of the metal sulfate and/or the stability of the additive while in use. SOx additives are relatively less effective for SOx transfer when used in partial burn operations. The utility of SOx additives for SOx transfer as additives for NOx reduction in partial burn is not well documented. Further, while good progress has been made in the full burn FCC mode for NOx reduction, on the order of 50% NOx reduction being achieved in the refinery, these same low NOx promoters and additives have not been successful in partial burn operation. The reasons for this are not understood, but the result implies that the art for NOx reduction in full burn FCC units cannot be taken as necessarily effective for NOx reduction in partial burn operation.

US 2004/0077492 A1 provides a description of the partial burn FCC process, although it fails to mention the importance of limiting the additional heat generation associated with coincidental CO oxidation. This application proposes a partial burn NOx reduction additive containing an alkali metal or possibly an alkaline earth metal, an oxygen storage component, and a precious metal on an acidic support. While data presented appears to suggest performance benefits, the test reactions of NH₃+CO+O₂ or NH₃+NO+O₂ in the absence of water and sulfur are not at all assured to be predictive of real performance.

The use of phosphorus in FCC is known from the perspectives of coke or activity improvement and contaminant metals passivation. U.S. Pat. No. 4,567,152, for example, discloses P/Al₂O₃ to lower coke production, but does not describe the addition of transition metal promoters or mention SOx or NOx reduction. Eberly discloses alkaline earth or other phosphate treatments of Al₂O₃ to provide improved activity, coke and gasoline selectivity in U.S. Pat. Nos. 4,454,241 and 4,977,122, but does not discuss addition of further transition metal promoters, nor anticipate any impact of the invention upon NOx or SOx production during regeneration.

Chin discloses in U.S. Pat. No. 5,002,654 the use of Zn compounds which alternatively include zinc phosphate for the reduction of FCC NOx. This disclosure presents credible NOx results from coke burning, but appears to focus on the full burn applications with excess oxygen, and provides no benefits for SOx reduction. Alkaline earths were not included nor were other transition metals.

Mitchell and Vogel showed in 4,707,461 that CaHPO₄ was ineffective as a vanadium trap in the FCC process, producing inferior yields, and did not disclose any compositions with significant levels of transition metal promoters in alkaline earth phosphates or their utility for NOx and SOx in FCC.

Selective catalytic oxidation reactions involving NH₃ are known outside the FCC art but these cannot be anticipated to readily apply to the substoichiometric combustion of coke in partial burn regeneration in FCC processing. Selective catalytic reduction (SCR) catalysts and processes are known but these processes generally operate at significantly lower temperatures, minor amounts of CO and consistently net oxidizing conditions (10 vol % O₂). Preferred SCR catalysts include V/TiO₂ and FeCe-zeolite beta as monoliths. SCR catalyst formulations must maximize the reaction of NO+NH₃ to N₂ and minimize the reaction of NH₃+O₂ to N₂ to be successful, but something approaching the opposite is desired for partial burn FCC. Phosphate stabilization of alumina-based catalyst supports in general is known as well. The use of transition metal promoted alkaline earth phosphates for relevant reactions of ammonia or NOx have not been proposed in this art so far as we are aware.

5,139,756 discloses selective catalytic oxidation of NH₃ at 400-600° C. using a fluidized catalyst containing Cu or V. Concentrated gases containing more NH₃ than CO₂ are used under net oxidizing conditions without CO. The combination of Cu or V with alkaline earth metals and phosphorus are not disclosed.

The hydrolysis or hydrogenolysis of HCN in coke oven gases has been studied and catalysts disclosed for this reaction are completely effective at temperatures as low as 150° C. These gases contain CO₂, CO, H₂O, H₂S and large amounts of H₂, and are generally net reducing. Supported transition metals are effective but not required to obtain nearly complete conversion for this facile reaction, but no guidance is obtained for selective oxidation under more relevant conditions. U.S. Pat. No. 5,993,763 shows that either SO₄/TiO₂ or P/TiO₂ or V/TiO₂ or alkaline earths on Mo/TiO₂ are effective in an atmosphere which contains 74% H₂. These results cannot be expected to readily apply to FCC.

The art for SOx transfer in FCC is more relevant for both SOx and NOx reduction in partial burn FCC, but the art does not disclose the additional use of phosphorus. The prevailing SOx additives in commercial use are apparently based on magnesium aluminum spinel formed before or during use in the FCC unit, this spinel being promoted with additional catalytic components for SO₂ oxidation and magnesium sulfate reduction. Bhattacharyya and Yoo in “Fluid Catalytic Cracking: Science and Technology,” J. S. Magee and M. M. Mitchell, Jr., Eds. Elsevier, have reviewed this art, which generally claims alkaline earth spinels such as magnesium or calcium aluminates over a range of ratios, with or without additional alkaline earth oxides present as free phases.

U.S. Pat. No. 4,472,267 discloses Ce, Pt, V, Fe, Sb or other oxidation promoters but the use of phosphorus is not disclosed. U.S. Pat. No. 4,469,589 generalizes these teachings and lists a vast array of compositions with the spinel lattice structure, leading one perhaps to believe that it is the spinel lattice itself which is essential to SOx transfer. Indeed it was well known that FCC catalysts containing generous amounts of SiAl spinel matrix could outperform the combination of conventional FCC catalyst with SOx additive for SOx transfer in the refinery. Platinum and other metals are proposed indiscriminately as oxidation promoters or spinel constituents, without anticipating any impact on, much less providing guidance for, NOx production results. The additional use of phosphorus was not disclosed and is conspicuously absent given the extensive listing that was provided.

U.S. Pat. No. 4,728,635 provides alkaline earth metal spinel compositions with improved attrition resistance and that may contain an SO₂ oxidation promoter and a sulfate reduction promoter, as well as a metal for carbon monoxide oxidation. Among the twelve possible sources of alkaline earth listed, phosphates are incidentally included (column 3, line 60), but no further mention of phosphorus or its potential benefits are made in the patent. Examples 13 to 19 assert a NOx benefit may be obtained during commercial FCC operation, but do not elaborate on or how to improve the NOx reductions. The patent is therefore not instructive on NOx.

U.S. Pat. No. 4,963,520 discloses spinel compositions that include third and fourth promoter metals to oxidize and reduce sulfur, but they must be other than Ce and V. NOx reduction is asserted in general and apparently found in Examples 31 and 32, but the patent does not reveal whether NOx was improved with respect to the C/V/Mg-Al spinel prior art nor which promoters have what effect.

U.S. Pat. No. 5,190,902 provides a phosphate and clay binder system which is described as “universally non-reactive” and can be applied to a multitude of systems to make attrition-resistant spray dried microspheres. Non-reactivity arises because the “clay ingredient reacts with the phosphate ingredient” (Column 4, line 16). The formation of ammonium aluminum phosphate and aluminum phosphate is theorized from the aluminum in the clay at extremes of pH. An auxiliary binder such as alumina or magnesia or other common materials might optionally be included, and, as an additional option, the microspheres may be impregnated with metals such as vanadium. Alternatively the P/clay system can be used to bind zeolites such as Y and ZSM-5. Alkaline earth phosphates are not listed as phosphate sources in Column 21 however, and no mention is made of SOx or NOx reactions or benefits in general. Nor are the specific combinations of transition metal promoted alkaline earth phosphates on alumina and their benefits for SOx and/or NOx disclosed.

U.S. Pat. No. 6,074,984 discloses SOx additive systems having separate microspheres of an SO₂₄→SO₃ oxidizer and an SO₃ sorbent, but makes no mention of any impact on NOx. Many combinations of known SO₂ oxidation catalysts and SO₃ sorbent materials are listed since the invention was the separate microsphere concept, and while each was subject to certain constraints, a wide range of possibilities was covered. Among the large number of possible options was the use of the “universally non-reactive” clay/phosphate binder of the previously noted U.S. Pat. No. 5,190,902 to bind the many known SO₃ sorbents of U.S. Pat. No. 6,074,984. These many known sorbents include magnesia, alumina, calcium aluminate, and calcium oxide (Column 10, line 53), which same listing goes on to name alkaline earth hydroxides, salts and silicates as other useful ingredients for the sorbents. Neither patent anticipates or discloses the special utility of alkaline earth phosphates as a raw material or formed product, with or without association with alumina or spinel supports, for the purpose of SOx or NOx reduction, either as a dual particle system or as a single particle additive.

### SUMMARY OF THE INVENTION

The present invention is directed to a catalyst additive and use thereof for reducing the amount of NOx and NOx precursors such as NH₃ and HCN in the effluent of an FCC regenerator. In accordance with this invention, addition of certain transition metals to alumina further doped with Group IIA metals and phosphorous yields catalysts having an increased activity for NOx and SOx reactions. Surprisingly improved selectivity is obtained for the selective oxidation of NH₃ to N₂ on these materials as compared to known combinations of vanadia, ceria and copper, which are the mainstays of the prior art for SOx and NOx reduction. Much lower selectivity to NOx is obtained than for precious metals, which are also commonly employed for regenerator oxidation reactions, along with a reduced CO oxidation activity. Most surprisingly, some of these materials are apparently very active as SOx transfer additives and have very rapid SOx uptake and release.

### DETAILED DESCRIPTION OF THE INVENTION

The present invention is used in connection with a fluid catalyst cracking process for cracking hydrocarbon feeds. The same hydrocarbon feeds normally processed in commercial FCC systems may be processed in a cracking system employing the present invention. Suitable feedstocks include, for example, petroleum distillates or residuals, either virgin or partially refined. Synthetic feeds such as coal oil and shale oils are also suitable. Suitable feedstocks normally boil in the range from about 200-600° C. or higher. A suitable feed may include recycled hydrocarbons which have already been subjected to cracking.

The catalytic cracking of these petroleum distillates, which are relatively high molecular weight hydrocarbons, results in the production of lower molecular weight hydrocarbon products. The cracking is performed in the catalytic cracking reactor which is separate and distinct from the catalyst regeneration zone. The cracking is performed in a manner in cyclical communication with a catalyst regeneration zone, commonly called a regenerator. Catalysts suitable in this type of catalytic cracking system include siliceous inorganic oxides, such as silica, alumina, or silica-containing cracking catalysts. The catalyst may, for example, be a conventional non-zeolitic cracking catalyst containing at least one porous inorganic oxide, such as silica, alumina, magnesia, zirconia, etc., or a mixture of silica and alumina or silica and magnesia, etc., or a natural or synthetic clay. The catalyst may also be a conventional zeolite-containing cracking catalyst including a crystalline aluminosilicate zeolite associated with a porous refractory matrix which may be silica-alumina, clay, or the like. The matrix generally constitutes 50-95 weight percent of the cracking catalyst, with the remaining 5-50 weight percent being a zeolite component dispersed on or embedded in the matrix. The zeolite may be rare earth-exchanged, e.g., 0.1 to 10 wt % RE, or hydrogen-exchanged. Conventional zeolite-containing cracking catalysts often include an X-type zeolite or a Y-type zeolite. Low (less than 1%) sodium content Y-type zeolites are particularly useful. All zeolite contents discussed herein refer to the zeolite content of the makeup catalyst, rather than the zeolite content of the equilibrium catalyst, or E-Cat. Much crystallinity is lost in the weeks and months that the catalyst spends in the harsh, steam filled environment of modern FCC regenerators, so the equilibrium catalyst will contain a much lower zeolite content by classical analytic methods. Most refiners usually refer to the zeolite content of their makeup catalyst. As will be apparent to those skilled in the art, the composition of the catalyst particles employed in the system is not a critical feature of the present method and, accordingly any known or useful catalyst is acceptable in this invention.

The catalyst inventory may contain one or more additives present as separate additive particles or mixed in with each particle of the cracking catalyst. Additives are sometimes used to enhance octane (medium pore size zeolites, sometimes referred to as shape selective zeolites, i.e., those having a Constraint Index of 1-12, and typified by ZSM-5, and other materials having a similar crystal structure).

It is desirable to separate the hydrocarbon products from the catalyst immediately after cracking. For this reason, a stripping zone is usually placed intermediate to the cracking reactor and the regenerator to cause quick or rapid disengagement of the hydrocarbon products from the catalyst. The stripping zone is maintained at a temperature of about 300° C. to about 600° C. and usually has an inert gas such as steam or nitrogen to aid the stripping.

The cracking conditions generally employed during the conversion of the higher molecular weight hydrocarbons to lower molecular weight hydrocarbons include a temperature of from about 425° C. to about 600° C. The average amount of coke deposited on the surface of the catalyst is between 0.5 weight percent and 2.5 weight percent depending on the composition of the feed material. Rapid disengagement after cracking is again achieved via the stripping zone. Again, conditions for cracking may vary depending on the refiner, feed composition, and products desired. The particular cracking parameters are not critical to the invention which contemplates successful removal of NH₃ and HCN from the regenerator over a widely varying range of cracking conditions.

Catalyst passed from the stripping zone to the catalyst regeneration zone will undergo regeneration in the presence of oxygen in the catalyst regeneration zone. This zone usually includes a lower dense bed of catalyst having a temperature of about 500° C. to 750° C. and a surmounted dilute phase of catalyst having a temperature of from about 500° C. to about 800° C. In order to remove the coke from the catalyst, oxygen is supplied in a stoichiometric or substoichiometric relationship to the coke on the spent catalyst. This oxygen may be added by means of any suitable sparging device in the bottom of the regeneration zone or, if desired, additional oxygen can be added in the dilute phase of the regeneration zone surmounted to the dense phase of catalyst. In this invention it is not necessary to provide an over-stoichimetric quantity of oxygen to operate the regeneration zone in a complete combustion mode as is currently in fashion in many FCC units. In fact, this invention has particular use if the regeneration zone is operated in a standard mode of operation which comprises a partial combustion mode or sometimes referred to as a reducing mode wherein the quantity of carbon monoxide in the regeneration zone is maintained at a level of from about 1 to 10 percent by volume of the regenerator flue gas.

Although most regenerators are controlled primarily by adjusting the amount of regeneration air added, other equivalent control schemes are available which keep the air constant and change some other condition. Constant air rate, with changes in feed rate changing the coke yield, is an acceptable way to modify regenerator operation. Constant air, with variable feed preheat, or variable regenerator air preheat, are also acceptable. Finally, catalyst coolers can be used to remove heat from a unit. If a unit is not generating enough coke to stay in heat balance, torch oil, or some other fuel may be burned in the regenerator.

When the regeneration zone is operated in a mode of partial combustion, the off gas stream contains a sizable amount of ammonia (NH₃) and HCN. The amount of ammonia, for example, may range from about 10 parts per million to 1000 parts per million, depending on the composition of the feed material. After requisite separation from the regenerated catalyst, the flue gas stream is passed to a CO boiler where CO is converted to CO₂ in the presence of oxygen. If the ammonia and HCN are allowed to enter the CO boiler, a portion or all of it may become converted to a NOx during the CO oxidation to CO₂.

In accordance with the present invention, an additive is provided in the regenerator to remove the ammonia and HCN gas which is formed so as to prevent the formation of NOx in the downstream CO boiler. The additive is particularly useful in regeneration units which are run under partial combustion conditions. Under such conditions, as well as under full burn conditions in the regenerator, the additive is also useful for NOx and SOx reduction.

The additives of this invention are transition metal-doped alkaline earth metal phosphates on alumina. The transition metal may include V, Cu, Mn, Sb, Fe, Ni, Zn, Co, Mo, or W. V, Cu, Sb, and Mn are particularly effective for NOx reduction. V is particularly useful for partial burn operation, providing the lowest CO oxidation activity together with very good NH₃ and HCN conversion activity at low NOx selectivity, as well as fast SOx oxidation and release kinetics. Cu is even more effective for NOx reduction, but the composition has higher CO oxidation activity. Surprisingly good performance for SOx is obtained when a single impregnation of Ca, P, and Fe is done, although these have low activity for NOx reactions. Mn has also given good results as a single metal dopant for NOx. Although single transition metals can be used as dopants, metal combinations can also be used.

The preferred additive of this invention comprises calcium, phosphorous, and transition metals contained on an alumina support. A preferred composition for the additive comprises the following: CaO (3 to 6 wt. %), P₂0₅ (3 to 5 wt. %), MOx (1 to 4 wt. %), wherein M is a transition metal, and x varies with the oxidation state of the metal, and alumina (85 to 93 wt. %). In general, Ca in the above formula can be replaced in part or completely by the stoichiometric equivalent of other Group IIA metals, in particular Mg or Ba. Those skilled in the art will readily recognize that if alternative Group IIA metals are used, they should be used in stoichiometrically equivalent amounts, and that the weight loadings of these oxides will be different. For example, the weight loading of BaO is nearly triple that of the equivalent moles of CaO. This is important because the sulfur uptake capacity is controlled on a stoichiometric basis.

As is customary and convenient, reference has been made to the catalyst composition of this invention as a mixture of oxides, e.g., CaO, P₂O₅, CuO, Fe₂O₃, and V₂O₅, but these oxides are not likely to always be present as pure bulk phases. It is expected that the materials are monolayer catalysts, or nearly so.

The vanadium catalysts are the most preferred of the transition metals from the point of view of partial burn NOx reduction because such catalysts provide the highest NH₃ conversion activity and selectivity to N₂ together with minimal CO oxidation activity. The vanadium-containing catalysts of this invention also have generally had the most favorable SOx transfer activity.

It has been found that compositions in the form of Ca₍₁₂₋ₙ₎P₆V₍ₙ₎ on alumina and having an increasing vanadium content have an increasing ammonia conversion activity. However, higher loadings of V appear to correlate with higher selectivity to NOx. Catalysts containing vanadium can be made by contacting the alumina support with aqueous solutions or suspensions of vanadium oxalate or ammonium vanadate, for example. The ammonium vanadate catalysts appear to be less active but more selective at constant targeted loading in CaPV recipes. The difference may be due in part to the fact that the oxalate was fully dissolved whereas the vanadate was only partly dissolved during the impregnations. Ammonium vanadate has nevertheless been used successfully in the art in general, apparently because of the tendency for vanadium to wet and migrate across support surfaces. Both vanadium precursors appear to be suitable. The selectivity of the vanadate is counterbalanced by the potential loss of vanadia powder during manufacturing.

Other transition metals have been found useful, among these, copper, manganese and iron are the most useful. Copper has been found to be surprisingly active at a low loading, and extremely selective to N₂. Higher copper loadings on other supports have led to higher NOx selectivity in other formulations, so the results are surprising. The CO oxidation activity of Ca₁₁P₆Cu₁ is higher than the vanadium recipes, but still much lower than conventional CO promoters such as platinum. Since as much as an order of magnitude higher additive dose is commonly employed for NOx and SOx reduction purposes, the lower CO oxidation activity of these materials may still be significant in terms of the FCC heat balance in partial burn mode.

Surprising results have been obtained using iron as the transition metal. Good SOx transfer activity was obtained with samples prepared in a single impregnation, single calcination sequence. Sample catalysts containing iron prepared using two sequences of impregnation-calcination were nearly ineffective.

Typically, up to 15 wt. %, more typically up to 10 wt. % loading of CaPMOx on alumina is useful, although a higher or lower loading may work as well after accounting for dilution. A particularly useful alumina support is Puralox from Sasol North America. This microspheroidal support has a fresh surface area of 95 m²/gm. Other alumina supports may be used. The loading may potentially need to be adjusted to keep the surface density of the active CaPM similar. Particle sizes of the alumina support can range from about 20 to 120 microns with an average particle size of about 65 to 85 microns, most preferably about 75-80 microns. More broadly, alpha-alumina and transitional aluminas are useful as supports for the additive of this invention. Moreover, aluminas containing minor amounts of doped metals or metal oxides are also acceptable. Such alumina-based supports should have about the same size as previously described.

It can be shown that aluminum phosphate is stable with respect to transitional and alpha aluminas, and that alkaline earth aluminum oxide spinels are stable with respect to the unmixed oxides, but that alkaline earth phosphates are stable with respect to each of the forgoing, all in the absence of SO₃. In the presence of SO₃ however, both the alkaline earth spinels and phosphates are unstable with respect to alkaline earth sulfates. This can be understood by reasoning that sulfuric acid is a stronger acid than phosphoric acid. It is presently hypothesized that the phosphates employed in the present invention may facilitate the formation and reduction of the alkaline earth sulfates via the formation of superficial coatings or highly dispersed quasi monolayers of stable alkaline earth phosphates on the alumina support, the phosphate component of which prevents the formation of the alkaline earth spinels of the prior art. Thus the present invention is distinguished over the prior art for reducing SOx by not being an alkaline earth spinel. It is speculated that SOx uptake and release in the FCC riser may be facilitated by this stabilization of highly dispersed alkaline earths because of the implicitly high surface exposure of the alkaline earth atoms and the sulfate groups, as opposed to having sulfate buried in the bulk of larger oxide/sulfate crystallites. The latter scenario may lead to a kinetic or mass transfer limitation due to the slow migration of the sulfate anions through the bulk alkaline earth oxide crystal lattice. Based on this speculation, it is presumed that phosphate is stored on the surface or in the bulk of the alumina support during sulfating under net oxidizing conditions, and that this phosphate can rapidly volatilize out of the alumina and readily diffuse through the gas phase to the alkaline earth metal sulfate/oxide under net reducing conditions, in order to facilitate reduction and stabilize the species in a non-spinel form. (Prestabilization of alumina by rare earth may serve a similar role.) Therefore, phosphorus loadings well in excess of stoichiometric alkaline earth phosphates are contemplated. The excess phosphate would be retained by the alumina support during redox cycling, which may enhance the stability of the additive over time.

Phosphoric acid is useful in providing the P content on the alumina support in the preparations. Ammonium phosphates may alternatively be used for P loading.

Examples of useful catalysts are shown in Table 1.

TABLE 1

| Recipe | Ca₉P₆V₃ | Ca₁₁P₆Cu₁ | Ca₁₀P₆Fe₂ |
|---|---|---|---|
| Atom mole Ratios | 9/6/3 | 11/6/1 | 10/6/2 |
| Support Material | Puralox | Puralox | Puralox |
| Grams catalyst | 100.00 | 100.00 | 100.00 |
| Grams of Support | 90.00 | 90.00 | 90.00 |
| Total MOx Loading, Wt % | 10.00 | 10.00 | 10.00 |

First Metal or Oxide Preparation

| | | | |
|---|---|---|---|
| Wt % Loading MOx | 4.19 | 5.50 | 4.89 |
| MOx Formula | CaO | CaO | CaO |

Second Metal or Oxide Preparation

| | | | |
|---|---|---|---|
| Wt % Loading MOx | 3.54 | 3.80 | 3.72 |
| MOx Formula | P2O5 | P2O5 | P2O5 |

Third Metal or Oxide Preparation

| | | | |
|---|---|---|---|
| Wt % Loading MOx | 2.27 | 0.71 | 1.39 |
| MOx Formula | V₂O₅ | CuO | Fe₂O₃ |

Typically, to provide the compositions of Table 1 and similar useful compositions, one Ca atom is removed for every transition metal atom added to the recipe: Ca(12-x)P₆M(x). Examples of typical compositional ranges are set forth in Table II.

TABLE II

| | Ca(12-x)P₆V(x) | Ca(12-x)P₆Fe(x) |
|---|---|---|
| Oxide analysis, VF | with V₂ to V₄ | with Fe₁ to Fe₃ |
| CaO, wt % | 4.80-3.62 | 5.49-4.31 |
| P₂O₅, wt % | 3.65-3.44 | 3.79-3.64 |
| Fe₂O₃ or V₂O₅, wt % | 1.56-2.94 | 0.71-2.05 |
| Al₂O₃, wt % | 90% | 90% |

### EXAMPLES 1-14

Examples of metal oxide-promoted alkaline earth phosphates have been prepared, and set forth in Tables 3 and 4. These examples, with one exception, were prepared with Ca. The transition metal used, the atom ratios and remaining details are specified in the Tables. The support material was common to all of the examples and was a microspheroidal transition alumina support (Puralox) with a fresh BET area of 95 m²/gm, an Average Particle Size of 74 microns, and an ABD of 0.90 g/cc. The incipient wetness pore volume of this material is about 0.5 ml H₂O/g of support, and salt solutions for Examples 1-11 were diluted to this volume basis. Examples 12-14 were prepared by diluting salt solutions to 0.31 ml/g support, which provided a dryer, free flowing mixture convenient for handling.

Generally 60 grams of support were impregnated several times with salt solutions to give the desired compositions, the total loading of these oxides in most cases being 10 Wt %. Several impregnations were sometimes employed to avoid the possibility that some of the dissolved metal oxides would precipitate or salt out. As a case in point, in most of the examples, the first metal oxide was CaO and the second P₂O₅. Hypothetical precipitation of calcium phosphates was avoided by loading phosphoric acid in the second or third impregnation, as is detailed in the Table. Later work (Examples 12-14) showed however that Ca and P in fact remained in solution when nitrate salts and phosphoric acid were used. Performance testing on the iron version made with two or one impregnation (Examples 11 vs. 13) later appeared to show that the sequence of impregnations was significant. When multiple impregnation steps were used, the impregnated samples were dried at about 200-250° F. overnight and then calcined for 2 hours at 1000° F. before further impregnations. The final calcinations were 2 hours at 1400° F. after all the metal oxides were loaded and dried.

When the promoting metal was a nitrate salt, it was combined with the calcium nitrate salt in the first impregnation, since these were presumed compatible. When the promoting metal oxide was an ammonium or other salt, i.e. ammonium vanadate or oxalate, it was impregnated in a separate step to avoid precipitation, which was assumed to lead to poor metal oxide distribution and performance. On the other hand, vanadium catalysts are commonly prepared with ammonium vanadate successfully in the art, although this salt has limited solubility. Apparently the affinity and mobility of vanadium for and on the surfaces of alumina and other supports is sufficient to lead to wetting and migration of vanadium during catalyst preparation. Later samples we prepared (Example 13) were made with fully dissolved vanadyl oxalate stock solution (Pechiney Inc., 11.1 Wt % V₂O₅) to determine whether the source of vanadium was important.

Further listed in the Tables are the Wt % loadings of the metal oxides, both as expected values by calculation and as actual values which were measured by XRF. Two XRF calibrations were used, one semiquantitative (SQ) and the other quantitative (Q), to determine the results reported.

A few of the examples in the Tables require special mention. Example 4 was intended to be of the composition Ca₁₀P₆Fe₂ and 10 Wt % loading of metal oxides on alumina. The SOx activity and NOx selectivity of this sample were unusually high, and repeated preparations were not able to reproduce this performance. It was later discovered that the sample erroneously contained an additional 5 Wt % V₂O₅, and the “(+V)” has been added to characterize this example to reflect the accident. It was the SOx results of this example that stood out and led to the realization that these NOx formulations were additionally useful for SOx.

Example 9 is an example of Mg/V on rare earth stabilized-Puralox alumina, which had additional doping with phosphorus. The support of Example 9 was prepared by impregnating the Puralox alumina used in the other examples with La-rich mixed rare earth nitrate solution which had been diluted to the incipient wetness pore volume of the support, in order to give a 10 Wt % loading of mixed rare earth oxides. This material was dried and then calcined at 1600° F. for two hours. The stabilized support was then loaded in three impregnations with MgVP, as indicated in Table 4.

TABLE 3
Preparation of metal oxide promoted calcium phosphates on alumina.

| Example | 1 | 2 | 3 | 4 |
|---|---|---|---|---|
| Elements combined | CaP | CaPV | CaPV | CaPFe(+V) |
| Atom mole Ratios | 12/6/0 | 11/6/1 | 9/6/3 | 10/6/2 |
| Grams of Support | 60.00 | 60.00 | 60.00 | 60.00 |
| Total MOx Loading, | 10.00 | 10.00 | 10.00 | 10.00 |
| wt % | | | | |

First Oxide Preparation

| | | | | |
|---|---|---|---|---|
| MOx Formula | CaO | CaO | CaO | CaO |
| Salt Formula | Ca(NO3)2*4H2O | Ca(NO3)2*4H2O | Ca(NO3)2*4H2O | Ca(NO3)2*4H2O |
| Grams Salt | 17.19 | 15.27 | 11.77 | 13.73 |
| Impregnated during | 1 | 1 | 1 | 1 |
| step | | | | |

Second Oxide Preparation

| | | | | |
|---|---|---|---|---|
| MOx Formula | P2O5 | P2O5 | P2O5 | P2O5 |
| Salt Formula | H3PO4 | H3PO4 | H3PO4 | H3PO4 |
| Grams Salt | 3.57 | 3.46 | 3.26 | 3.42 |
| Wt % of salt in stock | 50% | 50% | 50% | 50% |
| solution | | | | |
| Grams of salt stock | 7.13 | 6.91 | 6.51 | 6.84 |
| solution | | | | |
| Impregnated during | 2 | 3 | 3 | 2 |
| step | | | | |

Third Oxide Preparation

| | | | |
|---|---|---|---|
| MOx Formula | V2O5 | V2O5 | Fe2O3 |
| Salt Formula | NH4VO3 | NH4VO3 | Fe(NO3)3*9H2O |
| Grams Salt | 0.69 | 1.94 | 4.70 |
| Impregnated during | 2 | 2 | 1 |
| step | | | |

Calculated compositions

| | | | | |
|---|---|---|---|---|
| 1st MOx Loading | 6.12 | 5.44 | 4.19 | 4.89 |
| 2nd MOx Loading | 3.88 | 3.76 | 3.54 | 3.72 |
| 3rd MOx Loading | 0.00 | 0.80 | 2.27 | 1.39 |

Results of Preparation Work

| | | | | |
|---|---|---|---|---|
| Calc'n | 1400/2 h | 1400/2 h | 1400/2 h | 1400/2 h |
| Temp(F.)/Time(hrs) | | | | |
| XRF: | Q | SQ | Q | SQ |
| Quant/Semiquant | | | | |
| Wt % 1st Metal | 6.10 | 4.70 | 4.10 | 4.40 |
| (oxide) | | | | |
| Wt % 2nd Metal | 3.70 | 3.30 | 3.30 | 3.90 |
| (oxide) | | | | |
| Wt % 3rd Metal | | 0.80 | 2.80 | 1.40 |
| (oxide) | | | | |
| Wt % 4th Metal | | | | 5% V2O5 |
| (oxide) | | | | |
| BET, m2/gm | 68 | | 72 | |

| Example | 5 | 6 | 7 |
|---|---|---|---|
| Elements combined | CaPV | CaPNi | CaPCu |
| Atom mole Ratios | 10/1/2 | 11/6/1 | 11/6/1 |
| Grams of Support | 60.00 | 60.00 | 60.00 |
| Total MOx Loading, | 10.00 | 10.00 | 10.00 |
| wt % | | | |

First Oxide Preparation

| | | | |
|---|---|---|---|
| MOx Formula | CaO | CaO | CaO |
| Salt Formula | Ca(NO3)2*4H2O | Ca(NO3)2*4H2O | Ca(NO3)2*4H2O |
| Grams Salt | 19.35 | 15.50 | 15.43 |
| Impregnated during | 1 | 1 | 1 |
| step | | | |

Second Oxide Preparation

| | | | |
|---|---|---|---|
| MOx Formula | P2O5 | P2O5 | P2O5 |
| Salt Formula | H3PO4 | H3PO4 | H3PO4 |
| Grams Salt | 0.80 | 3.51 | 3.49 |
| Wt % of salt in stock | 50% | 50% | 50% |
| solution | | | |
| Grams of salt stock | 1.61 | 7.02 | 6.99 |
| solution | | | |
| Impregnated during | 3 | 2 | 2 |
| step | | | |

Third Oxide Preparation

| | | | |
|---|---|---|---|
| MOx Formula | V2O5 | NiO | CuO |
| Salt Formula | NH4VO3 | Ni(NO3)2*6H2O | Cu(NO3)2*2.5H2O |
| Grams Salt | 1.92 | 1.73 | 1.38 |
| Impregnated during | 2 | 1 | 1 |
| step | | | |

Calculated compositions

| | | | |
|---|---|---|---|
| 1st MOx Loading | 6.89 | 5.52 | 5.50 |
| 2nd MOx Loading | 0.87 | 3.81 | 3.80 |
| 3rd MOx Loading | 2.24 | 0.67 | 0.71 |

Results of Preparation Work

| | | | |
|---|---|---|---|
| Calc'n | 1400/2 h | 1400/2 h | 1400/2 h |
| Temp(F.)/Time(hrs) | | | |
| XRF: | SQ | SQ | |
| Quant/Semiquant | | | |
| Wt % 1st Metal | 6.50 | 5.40 | na |
| (oxide) | | | |
| Wt % 2nd Metal | 0.90 | 3.10 | na |
| (oxide) | | | |
| Wt % 3rd Metal | 2.00 | 0.64 | na |
| (oxide) | | | |
| Wt % 4th Metal | | | |
| (oxide) | | | |
| BET, m2/gm | | | |

TABLE 4
Preparation of metal oxide promoted calcium or magnesium phosphates on alumina.

| Example | 8 | 9 | 10 | 11 |
|---|---|---|---|---|
| Elements | CaPMn | MgVP | CaPV | CaPFe |
| combined | | | | |
| Atom mole Ratios | 11/6/1 | 3/2/0.2 | 9/6/3 | 10/6/2 |
| Support Material | Puralox | RE/Puralox | Puralox | Puralox |
| Grams of Support | 60.00 | 100.00 | 600.00 | 600.00 |
| Total MOx | 10.00 | 8.71 | 10.00 | 10.00 |
| Loading Wt % | | | | |

First Oxide Preparation

| | | | | |
|---|---|---|---|---|
| MOx Formula | CaO | MgO | CaO | CaO |
| Salt Formula | Ca(NO3)2*4H2O | Mq(NO3)2*6H2O | Ca(NO3)2*4H2O | Ca(NO3)2*4H2O |
| Grams Salt | 15.11 | 23.16 | 117.73 | 137.32 |
| Impregnated | 1 | 1 | 1 | 1 |
| during step | | | | |

Second Oxide Preparation

| | | | | |
|---|---|---|---|---|
| MOx Formula | P2O5 | V2O5 | P2O5 | P2O5 |
| Salt Formula | H3PO4 | NH4VO3 | H3PO4 | H3PO4 |
| Grams Salt | 3.42 | 7.05 | 32.57 | 34.19 |
| Wt % of salt in | 50% | | 50% | 50% |
| stock solution | | | | |
| Grams of salt | 6.84 | 14.09 | 65.14 | 68.38 |
| stock solution | | | | |
| Impregnated | 2 | 2 | 3 | 2 |
| during step | | | | |

Third Oxide Preparation

| | | | | |
|---|---|---|---|---|
| MOx Formula | MnO3 | P2O5 | V2O5 | Fe2O3 |
| Salt Formula | Mn(NO3)2*xH2O | (NH4)2HPO4 | NH4VO3 | Fe(NO3)3*9H2O |
| Grams Salt | 1.04 | 0.80 | 19.44 | 46.98 |
| Wt % of salt in | | | | |
| stock solution | | | | |
| Grams of salt | | | | |
| stock solution | | | | |
| Impregnated | 1 | 3 | 2 | 1 |
| during step | | | | |

Calculated compositions

| | | | | |
|---|---|---|---|---|
| 1st MOx Loading | 5.38 | 3.32 | 4.19 | 4.89 |
| 2nd MOx Loading | 3.72 | 5.00 | 3.54 | 3.72 |
| 3rd MOx Loading | 0.90 | 0.39 | 2.27 | 1.39 |

Results of Preparation Work

| | | | | |
|---|---|---|---|---|
| Calc'n | 1400/2 h | 1400/2 h | 1400/2 h | 1400/2 h |
| Temp(F.)/Time(hrs) | | | | |
| XRF: | | SQ | Q | Q |
| Quant/Semiquant | | | | |
| Wt % 1st Metal | | 4.32 | 4.4 | 5.1 |
| (oxide) | | | | |
| Wt % 2nd Metal | | 3.29 | 3.3 | 3.1 |
| (oxide) | | | | |
| Wt % 3rd Metal | | 0.35 | 2.2 | 1.4 |
| (oxide) | | | | |

| Example | 12 | 13 | 14 |
|---|---|---|---|
| Elements | CaPV | CaPV | CaPFe |
| combined | | | |
| Atom mole Ratios | 9/6/3 | 9/6/3 | 10/6/2 |
| Support Material | Puralox | Puralox | Puralox |
| Grams of Support | 200.00 | 200.00 | 200.00 |
| Total MOx | 10.00 | 10.00 | 10.00 |
| Loading Wt % | | | |

First Oxide Preparation

| | | | |
|---|---|---|---|
| MOx Formula | CaO | CaO | CaO |
| Salt Formula | Ca(NO3)2*4H2O | Ca(NO3)2*4H2O | Ca(NO3)2*4H2O |
| Grams Salt | 39.24 | 39.24 | 45.77 |
| Impregnated | 1 | 1 | 1 |
| during step | | | |

Second Oxide Preparation

| | | | |
|---|---|---|---|
| MOx Formula | P2O5 | P2O5 | P2O5 |
| Salt Formula | H3PO4 | H3PO4 | H3PO4 |
| Grams Salt | 10.86 | 10.86 | 11.40 |
| Wt % of salt in | 50% | 50% | 50% |
| stock solution | | | |
| Grams of salt | 21.71 | 21.71 | 22.79 |
| stock solution | | | |
| Impregnated | 1 | 1 | 1 |
| during step | | | |

Third Oxide Preparation

| | | | |
|---|---|---|---|
| MOx Formula | V2O5 | V2O5 | Fe2O3 |
| Salt Formula | NH4VO3 | Vanadyl oxalate | Fe(NO3)3*9H2O |
| Grams Salt | 6.48 | 5.04 | 15.66 |
| Wt % of salt in | | 11.1% | |
| stock solution | | | |
| Grams of salt | | 45.38 | |
| stock solution | | | |
| Impregnated | 2 | 2 | 1 |
| during step | | | |

Calculated compositions

| | | | |
|---|---|---|---|
| 1st MOx Loading | 4.19 | 4.19 | 4.89 |
| 2nd MOx Loading | 3.54 | 3.54 | 3.72 |
| 3rd MOx Loading | 2.27 | 2.27 | 1.39 |

Results of Preparation Work

| | | | |
|---|---|---|---|
| Calc'n | 1400/2 h | 1400/2 h | 1400/2 h |
| Temp(F.)/Time(hrs) | | | |
| XRF: | | Q | Q |
| Quant/Semiquant | | | |
| Wt % 1st Metal | | 4.4 | 5 |
| (oxide) | | | |
| Wt % 2nd Metal | | 3 | 3.3 |
| (oxide) | | | |
| Wt % 3rd Metal | | 3.6 | 1.5 |
| (oxide) | | | |

### EXAMPLES 15-35

Blends containing 20% of the experimental additives and 80% of a standard zeolitic FCC catalyst were made, with a portion of each of these blends being steamed at 1500° F. for 2 hours and the remaining portion not steamed. The steamed and not steamed blends were then recombined as blends of 50% steamed and 50% non-steamed, each recombined blend therefore containing 10% steamed additive and 10% unsteamed additive. 2 grams of the resulting 80/20-50/50 blends were then placed in a test apparatus with the reaction zone at 1300° F. Test gases which contained representative amounts of CO₂, CO, H₂O, O₂, SO₂, NO, HCN, NH₃ and inert diluent were admitted to the catalyst mixtures in the reactor at a space velocity with respect to the additive which is representative of an FCC regenerator operating with an E-cat containing 2% additive, noting that 2% additive is 1/10^{th} that of the additive content of the test blends. The effluent of the reactor was analyzed and the molar compositions determined after about 30-60 minutes on stream and these are collected in Tables 5-7.

A blank run made with 2 grams of steamed clay microspheres (Example 15) produced 1627 μmol CO₂ and 1190 μmol CO, consistent with a partial combustion process, as well as 29 μmol of HCN, 67 μmol of NH₃, 9 μmol NOx, 6.4 μmol N₂O, and 17.2 μmol of nitrogen atoms in the form of N₂, designated as 2*N2 in the Table. Also found was 14 μmol of SO₂ and 1 μmol of COS. Not all of the sulfur species could be determined and although unlikely in this case, some S could have been adsorbed. The net S deficit was 3.5 μmols by material balance.

Example 16 was made with 2 grams of a fully promoted refinery equilibrium catalyst containing a Pt-based CO promoter. Compared to the clay blank of Example 15, the E-cat reduced the yield of HCN and NH₃, making about 50 μmol of N as N₂, but about 18 μmol of NOx. It is well known that Pt promoters increase the yield of NOx. Since the same weight of E-cat was used as the other examples and the Pt promoter was not enriched, this test represents 1/10^{th} the typical Pt dose or 10 times the typical space velocity with respect to the promoter typical of full burn FCC.

80/20-50/50 blend results are now described. In Example 17, a blend of FCC catalyst now containing 20% of the clay microspheres of Example 15 was tested, and this made about 21 μmol of N₂ and very little NOx. Almost all of the HCN was converted, but later testing showed that this was largely due to hydrolysis by the unsteamed FCC fraction, which was 40% of the blend. When the FCC catalyst was blended 80/20-50/50 with unmodified alumina support microspheres (Example 18), somewhat more N2 and slightly less HCN and NOx were made. A sample of alumina doped with 10 Wt % of Ca₁₂P₆ (tested in Example 19, prepared in Example 1) increased N₂ by about 5 μmol and NOx by about 3 μmol, so the CaP has some activity all by itself. Doping the Ca₁₂P₆ recipe with V, Cu, Mn, Fe, or FeV (Examples 20-28) increased yields to as high as 40 μmol N₂ (80 μmol as N), in most cases with low NOx and CO oxidation. An exception was Example 22, which was the sample of Ca₁₀P₆Fe₂ which was inadvertently loaded with high levels of vanadium.

TABLE 5
Performance data.

| Example | 15 | 16 | 17 | 18 | 19 | 20 | 21 |
|---|---|---|---|---|---|---|---|
| Example for | | | | | 1 | 2 | 3 |
| preparation | | | | | | | |
| Components | Clay | Pt Ecat | FCC/Clay | FCC/Al2O3 | CaP | CaPV | CaPV |
| | blank | | | | | | |
| Atom Ratios | | | | | 12/6/0 | 11/6/1 | 9/6/3 |

Micromoles of product gases

| | | | | | | | |
|---|---|---|---|---|---|---|---|
| CO₂ | 1627 | 2047 | 1752 | 1731 | 2091 | 1904 | 2130 |
| CO | 1190 | 785 | 1176 | 1087 | 868 | 1026 | 716 |
| H₂O | 3945 | 4088 | 3907 | 3939 | 4047 | 3969 | 4029 |
| 2*N₂ | 17.2 | 49.8 | 41.1 | 45.0 | 55.8 | 57.3 | 67.6 |
| HCN | 29.1 | 10.89 | 4.22 | 1.11 | 0.39 | 0.72 | 0.16 |
| NH₃ | 66.8 | 43.46 | 73.01 | 71.97 | 59.91 | 58.69 | 49.07 |
| NO | 4.9 | 14.77 | 0.96 | 1.67 | 1.77 | 1.42 | 2.51 |
| NO₂ | 4.1 | 3.33 | 3.62 | 2.40 | 5.21 | 4.58 | 3.04 |
| N₂O | 6.4 | 5.77 | 3.13 | 5.06 | 1.78 | 0.22 | 3.22 |
| N total | 134.7 | 133.81 | 129.15 | 132.29 | 126.67 | 123.16 | 128.80 |
| SO₂ | 14.4 | 11.27 | 9.83 | 16.07 | 7.33 | 12.53 | 12.58 |
| COS | 1.4 | 0.33 | 0.55 | 0.55 | 0.93 | 0.62 | 1.36 |
| S Balance | 3.5 | 7.84 | 9.73 | 2.72 | 12.06 | 6.98 | 5.60 |
| k(COP) | 0.03 | 13.794 | 0.035 | 0.048 | 0.092 | 0.064 | 0.169 |
| W*k(COP) | 0.011 | 0.138 | 0.014 | 0.019 | 0.037 | 0.026 | 0.068 |
| S uptake | 1.4 | 3.22 | 3.88 | 3.04 | 6.15 | 6.38 | 5.45 |
| S release | 1.1 | 2.34 | 2.72 | −1.12 | 2.18 | −1.25 | −1.35 |

TABLE 6
Performance data, continued.

| Example | 22 | 23 | 24 | 25 | 26 | 27 | 28 |
|---|---|---|---|---|---|---|---|
| Example for | 4 | 5 | 6 | 7 | 8 | | 9 |
| preparation | | | | | | | |
| Components | CaPFe(+V) | CaPV | CaPNi | CaPCu | CaPMn | MgV | MgVP |
| Atom Ratios | 10/6/2 | 10/1/2 | 11/6/1 | 11/6/1 | 11/6/1 | 3/2 | 3/2/0.2 |

Micromoles of product gases

| | | | | | | | |
|---|---|---|---|---|---|---|---|
| CO₂ | 2474 | 2212 | 1891 | 2492 | 2315 | 2251 | 2018 |
| CO | 590 | 808 | 1127 | 463 | 648 | 695 | 845 |
| H₂O | 4360 | 4174 | 4011 | 4014 | 4096 | 4087 | 4519 |
| 2*N₂ | 79.1 | 68.5 | 38.8 | 80.0 | 68.1 | 78.1 | 75.7 |
| HCN | 0.12 | 0.19 | 1.45 | 0.16 | 0.35 | 0.1 | 0.40 |
| NH₃ | 27.81 | 47.30 | 76.50 | 33.14 | 48.31 | 27.7 | 43.16 |
| NO | 12.91 | 1.71 | 1.87 | 5.03 | 1.58 | 13.8 | 1.44 |
| NO₂ | 3.88 | 5.60 | 4.91 | 4.52 | 4.77 | 3.3 | 1.77 |
| N₂O | 1.67 | 1.30 | 3.89 | 0.82 | 0.31 | 4.1 | 4.32 |
| N total | 127.13 | 125.91 | 131.29 | 124.52 | 123.75 | 131.1 | 131.11 |
| SO₂ | 14.91 | 6.65 | 5.48 | 1.76 | 1.41 | 13.8 | 15.03 |
| COS | 0.37 | 1.00 | 0.52 | 0.17 | 0.50 | 0.4 | 0.53 |
| S Balance | 5.76 | 13.10 | 14.73 | 18.36 | 18.44 | 6.0 | 4.10 |
| k(COP) | 0.206 | 0.115 | 0.042 | 0.531 | 0.277 | 0.18 | 0.099 |
| W*k(COP) | 0.083 | 0.046 | 0.017 | 0.212 | 0.111 | 0.072 | 0.040 |
| S uptake | 6.13 | 6.12 | 6.27 | 6.50 | 6.57 | 6.2 | 4.54 |
| S release | −2.10 | 2.57 | 3.52 | 5.94 | 5.90 | −1.9 | −1.51 |

Comparative runs (Examples 29, 33) with the prevailing Ce-V-promoted magnesium aluminum spinel SOx additive confirmed a typical SOx additive can make N2 over and above FCC catalyst, but these have significant selectivity to NOx and significant CO oxidation activity. The relative rate constant for CO oxidation per gram of additive was determined at standardized conditions and is reported in Tables 5-7 as k(COP). In most cases the additive dose was 20 Wt % in the blend, but the Pt promoter content of the E-cat would have been much lower, and assumed to be 0.5 Wt % in estimating the activity of that promoter. Another run on a fresh CO promoter containing 500 ppm Pt gave a fresh k(COP) of about 70. The results show that the CaPV additives have roughly two orders of magnitude lower CO oxidation activity than equilibrium Pt on a per gram additive basis. Since one order of magnitude higher dose of NOx additive is typically used than for CO promoter however, the contribution of these additives to CO oxidation and the heat balance of a partial burn unit are not necessarily negligible. This effect is weighed by calculating W*k(COP), which represents the product of additive dose and the specific rate constant. Comparison of the various formulations shows that CaPCu and CaPMn have relatively higher CO oxidation activities, similar to the Comparative SOx additive runs of Examples 29 and 33. Optimally formulated CaPV recipes have higher N₂, lower NOx, and lower CO oxidation activity. The CaPCu and CaPMn results are still very useful however, since these have high N₂ yields with low or moderate NOx which are improved over the conventional SOx additive.

The relative activity for these materials for sulfur uptake and release was also determined by standardized methods, leading to the surprising result that many of these formulations not only outperformed the comparative SOx additive for NOx, but also for SOx release. That the values for steamed clay control of Example 15 gave uptake and release different from zero probably represents the limits of precision of the test. Most of the samples uptake SOx equivalently, but relatively few provide the large negative numbers that would represent an equivalent SOx release. It is well appreciated in the art that improvements in the SOx release properties are needed. The Al₂O₃ control of Example 18 releases SOx well, but the uptake is small because of weak adsorption, as is well known. Adding CaP to alumina improves uptake but without release. Further adding V (Ex. 20, 21) while maintaining P at elevated levels (contrary to Ex. 23) leads to good uptake and release, along with good NOx. Example 23 appears to show that SOx release is not rapid unless significant (P=6) levels of phosphorus are present. Higher levels of V can be used, possibly in conjunction with Fe (Ex. 22), but at the price of increased selectivity to NOx. Adding P at low doses can apparently improve the selectivity to NOx (Ex. 27 vs. 28), although low doses may not be effective for improving SOx release. Perhaps surprisingly, the Comparative Examples 29 and 33 did not release SOx well. These runs have been somewhat inconsistent and other runs have shown more favorable results for the Comparative samples. CaP doped with Ni, Cu or Mn also did not demonstrate SOx release. Not all of the S compounds could be evaluated so the results are potentially not quantitative. TGA results agree however that the CaPV formulations have consistently improved uptake and release kinetics versus the Comparative sample that represents the state of the art.

Test Examples 30-33 compare various impregnation/calcinations and precursors for making CaPV₃. Higher N₂ production was observed for the 2×2 vanadate and oxalate processes, although at higher NOx selectivity. Some of this may be due to higher than expected V loading. Nevertheless, the NOx and N2 selectivity remain better than the known SOx additive. Each also surprisingly has better SOx release than the known SOx additive. Examples 34 and 35 gave the unpredictable and unexplained if not surprising result that impregnation sequence drastically affects the CaPFe catalyst selectivity. These two samples have no vanadium in them. The 1×1 sample gave much better SOx release than the 2×2, although its activity for N₂ production was modest.

TABLE 7
Performance data, final runs.

| Example | 29 | 30 | 31 | 32 | 33 | 34 | 35 |
|---|---|---|---|---|---|---|---|
| Example for | | 10 | 12 | 13 | | 14 | 11 |
| preparation | | | | | | | |
| Components | Comparative | CaPV | CaPV | CaPV | Compar- | CaPFe | CaPFe |
| | | 3 × 3 | 2 × 2 | Oxalate | ative | 1 × 1 | 2 × 2 |
| Atom Ratios | | 9/6/3 | 9/6/3 | 9/6/3 | | 10/6/2 | 10/6/2 |

Micromoles of product gases

| | | | | | | | |
|---|---|---|---|---|---|---|---|
| CO₂ | 2463 | 2171 | 2020 | 2143 | 2505 | 2132 | 2472 |
| CO | 412 | 724 | 788 | 746 | 307 | 717 | 289 |
| H₂O | 4116 | 4017 | 3926 | 4174 | 4001 | 3987 | 3997 |
| 2*N₂ | 67.0 | 69.6 | 79.9 | 80.5 | 60.9 | 53.1 | 63.0 |
| HCN | 0.08 | 0.15 | 0.28 | 0.52 | 0.13 | 0.69 | 0.1 |
| NH₃ | 42.64 | 48.63 | 31.96 | 32.85 | 45.43 | 60.88 | 54.3 |
| NO | 9.64 | 2.21 | 7.25 | 6.48 | 12.70 | 4.74 | 1.0 |
| NO₂ | 3.17 | 3.03 | 2.52 | 2.15 | 2.95 | 3.00 | 3.2 |
| N₂O | 0.75 | 3.20 | 4.67 | 3.97 | 2.65 | 3.80 | 1.6 |
| N total | 124.05 | 130.06 | 131.27 | 130.39 | 127.45 | 129.99 | 124.8 |
| SO₂ | 6.30 | 9.90 | 11.67 | 17.23 | 10.44 | 12.99 | 9.9 |
| COS | 0.44 | 1.19 | 0.41 | 0.62 | 1.02 | 0.33 | 1.0 |
| S Balance | 13.00 | 8.79 | 7.21 | 1.98 | 7.86 | 6.24 | 8.0 |
| k(COP) | 0.364 | 0.144 | 0.127 | 0.176 | 0.471 | 0.161 | 0.483 |
| W*k(COP) | 0.146 | 0.058 | 0.051 | 0.071 | 0.188 | 0.064 | 0.193 |
| S uptake | 6.75 | 6.19 | 6.60 | 6.19 | 3.49 | 6.58 | 3.6 |
| S release | 2.27 | −0.21 | −1.56 | −4.58 | 2.10 | −2.05 | 2.3 |

1.-18. (canceled)

19. A method of regenerating an FCC catalyst in a regenerator and reducing NOx or Nox precursors and/or SOx or SOx precursors in the regenerator flue gas comprising: adding to said regenerator a catalyst additive comprising an alkaline earth metal, phosphorous, and at least one transition metal on an alumina-based support.

20. The method of claim 19 wherein said regenerator contains SOx or SOx precursors.

21. The method of claim 19 wherein said regenerator is operated under partial burn conditions.

22. The method of claim 21 wherein said catalyst additive contains calcium as said alkaline earth metal.

23. The method of claim 22 wherein said catalyst additive contains at least one transition metal is selected from the group consisting of V, Cu, Mn, Sb, Fe, Ni, Zn, Co, Mo, and W.

24. The method of claim 23 wherein said catalyst additive contains at least one transition metal is selected from the group consisting of V, Cu, Fe, Sb, and Mn.

25. The method of claim 21 wherein said transition metal is vanadium.

26. The method of claim 19 wherein said catalyst additive contains at least one transition metal selected from the group consisting of V, Cu, Mn, Sb, Fe, Ni, Zn, Co, Mo, and W.

27. The method of claim 26 wherein said catalyst additive contains at least one transition metal selected from the group consisting of V, Cu, Fe, Sb, and Mn.

28. The method of claim 27 wherein said alkaline earth metal is calcium.

29. The method of claim 19 wherein said additive comprises about 85-95 wt. % of said alumina-based support.

30. The method of claim 20 wherein said regenerator is operated under full burn conditions.
